(19) United States
(12) Patent Application Publication
(10) Pub. No.: US 2026/0046680 A1
(43) Pub. Date: Feb. 12, 2026

(54) QoS flow to DRB Remapping or Packet Shifting

(71) Applicant: Apple Inc., Cupertino, CA (US)

(72) Inventors: Ralf ROSSBACH, Munich (DE); Bobby JOSE, San Diego, CA (US); Pavan NUGGEHALLI, San Carlos, CA (US); Vijay VENKATARAMAN, San Jose, CA (US)

(21) Appl. No.: 19/101,507

(22) PCT Filed: Aug. 8, 2023
(86) PCT No.: PCT/US2023/029748

§ 371 Date: Feb. 5, 2025

Related U.S. Application Data
(60) Provisional application No. 63/370,748, filed on Aug. 8, 2022.

(51) Int. Cl. H04W 28/02

(52) U.S. Cl. CPC H04W 28/0268; H04W 28/0278

(57) ABSTRACT

A unit equipment (UE) configured to establish a protocol data unit (PDU) session including one or more quality of service (QoS) flows and multiple data radio bearers (DRB) for communications with a network, decode, from signals received from the network, or determine an initial mapping table for a QoS flow to DRB mapping based on a network configuration of mapping parameters, decode, from signals received from the network, or determine information regarding current or upcoming traffic on the one or more QoS flows or one or more DRBs, and configure transceiver circuitry to transmit an indication to the network based on the information regarding current or upcoming traffic on the one or more QoS flows or one or more DRBs.

### PRIORITY/INCORPORATION BY REFERENCE

This application claims priority to U.S. Provisional Application Ser. No. 63/370,748 filed on Aug. 8, 2022, and entitled “QoS flow to DRB Remapping or Packet Shifting,” the entirety of which is incorporated herein by reference.

### BACKGROUND

A user equipment (UE) may establish a connection to at least one of a plurality of different networks or types of networks, for example a 5G New Radio (NR) radio access technology (RAT). The UE may access external data networks (DN), such as extended reality (XR) or industrial Internet of Things (IIoT) services, via the 5G NR radio access network (RAN) and 5G-Core (5GC). During operation, some services may utilize multiple parallel data flows in the uplink (UL) and/or downlink (DL). In XR, for example, there may be a video stream, an audio stream and/or other data streams in the DL and there may be a control stream, a pose stream and/or other data streams in the UL. These data streams can be associated with multiple parallel QoS flows. Some traffic may have high throughput and low latency requirements, while other traffic may have more relaxed requirements, for these data flows transmitted in parallel.

According to current specifications, only the network/gNB can trigger an update of the QoS flow to DRB mapping of UL and DL traffic. However, depending on the mapping of QoS flows to logical channels, the data queues at the UE side can fill up very quickly. Delays on one or more DRBs can lead to a degradation of service and/or user experience when some packets do not arrive within latency bounds.

In some scenarios, the UE is better equipped than the network to analyze current or anticipated upcoming traffic usage, e.g., for application data on the UL. It would be useful for a UE to influence the selection of DRB resources for traffic flows and/or provide information to the network to better inform the network selection of DRB resources for traffic flows.

### SUMMARY

Some exemplary embodiments are related to an apparatus of a user equipment (UE), the apparatus having processing circuitry configured to establish a protocol data unit (PDU) session including one or more quality of service (QoS) flows and multiple data radio bearers (DRB) for communications with a network, decode, from signals received from the network, or determine an initial mapping table for a QoS flow to DRB mapping based on a network configuration of mapping parameters, decode, from signals received from the network, or determine information regarding current or upcoming traffic on the one or more QoS flows or one or more DRBs, and configure transceiver circuitry to transmit an indication to the network based on the information regarding current or upcoming traffic on the one or more QoS flows or one or more DRBs.

Other exemplary embodiments are related to a processor configured to establish a protocol data unit (PDU) session including one or more quality of service (QoS) flows and multiple data radio bearers (DRB) for communications with a network, decode, from signals received from the network, or determine an initial mapping table for a QoS flow to DRB mapping based on a network configuration of mapping parameters, decode, from signals received from the network, or determine information regarding current or upcoming traffic on the one or more QoS flows or one or more DRBs, and configure transceiver circuitry to transmit an indication to the network based on the information regarding current or upcoming traffic on the one or more QoS flows or one or more DRBS.

Still further exemplary embodiments are related to an apparatus of a base station, the apparatus having processing circuitry configured to establish a protocol data unit (PDU) session including one or more quality of service (QoS) flows and multiple data radio bearers (DRB) for communications with a user equipment (UE), indicate mapping parameters for the UE to determine an initial mapping table for a QoS flow to DRB mapping, configure the UE for transmitting an indication to the base station based on information regarding current or upcoming traffic on the one or more QoS flows or one or more DRBs and decode, from signals received from the UE, the indication.

Additional exemplary embodiments are related to a processor configured to establish a protocol data unit (PDU) session including one or more quality of service (QoS) flows and multiple data radio bearers (DRB) for communications with a user equipment (UE), indicate mapping parameters for the UE to determine an initial mapping table for a QoS flow to DRB mapping, configure the UE for transmitting an indication to the base station based on information regarding current or upcoming traffic on the one or more QoS flows or one or more DRBs and decode, from signals received from the UE, the indication.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary network arrangement for QoS flow and DRB mapping according to various exemplary embodiments.

FIG. 5a shows a diagram for QoS flow mapping at the SDAP layer according to various exemplary embodiments.

FIG. 5b shows a DL SDAP header according to various exemplary embodiments.

FIG. 5c shows a UL SDAP header according to various exemplary embodiments.

FIG. 5d shows a DL SDAP data PDU format with a DL SDAP header according to various exemplary embodiments.

FIG. 5e shows a UL SDAP data PDU format with a UL SDAP header according to various exemplary embodiments.

FIG. 6a shows an exemplary diagram for a UE remapping one or more packets from a first DRB to a second DRB based on buffer status according to various exemplary embodiments.

FIG. 6b shows a method for a UE remapping packets from a first DRB to a second DRB based on buffer status according to various exemplary embodiments.

FIG. 6c shows an exemplary diagram for a UE shifting one or more packets from a first DRB to a second DRB based on a critical status of the packets according to various exemplary embodiments.

FIG. 6d shows a method for a UE shifting one or more packets from a first DRB to a second DRB based on a critical status of the packets according to various exemplary embodiments.

FIG. 7 shows a method for UE-initiated operations for QoS flow to DRB remapping or packet shifting according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for a user equipment (UE) to initiate operations for a quality of service (QoS) flow to data radio bearer (DRB) remapping or packet shifting based on information determined or received by the UE. In particular, the UE can consider information/commands received from the application layer and/or events detected at the UE with respect to current or anticipated upcoming data usage. Based on this information, the UE can initiate a QoS flow remapping, packet shifting (to another DRB), or UE assistance information for the network to make QoS flow or DRB-related decisions. Alternatively, the UE can also consider information/commands/configuration received from the network when initiating a QoS flow to DRB remapping or packet shifting. Further, packet shifting can be combined with active queue management (AQM) principles.

In some scenarios, including Internet Protocol (IP) and/or Ethernet data traffic for extended reality (XR) or industrial Internet of Things (IIoT) services, multiple QoS flows having different throughput and/or latency requirements can be transmitted in parallel on multiple DRBs. Delays on one DRB can negatively affect the user experience. In some scenarios, it may be more efficient for the UE to initiate or request a QoS flow remapping and/or shifting of packets to a different DRB.

According to some aspects, the UE can receive information/commands from the application layer regarding current or upcoming traffic for/from the application. In other aspects, the UE (lower layers, e.g., service data adaptation protocol (SDAP), packet data convergence protocol (PDCP), radio link control (RLC) or medium access control (MAC) ) can detect events including, e.g., a high buffer status for a DRB/LCH, a high round trip time (RTT), a high amount of retransmissions (either on RLC or HARQ level), the UE nearing the packet delay budget (PDB) for a given data flow (e.g., based on the PDCP discard timer or according to a new parameter configured by the network, or based on an estimation internal to the UE and relating to the PDB for the 5QI/QFI), a PDU Set delay threshold, a packet error rate, a PDU Set error rate, the UE has entered survival time state, and other events related to a transmission time or delay time for packets on the DRB/LCH. The UE can determine to initiate a remapping of a QoS flow to a different DRB or to shift some packets to a different DRB without remapping the QoS flow. In still other aspects, the UE can provide assistance information to the network in, e.g., a UL transmission (UL SDAP PDU) or in UL RRC signaling, that can influence network operations with regard to the QoS flow or DRB. In one example, the UE can determine and indicate that a connection to an application has closed and that no further traffic should be expected on a particular QoS flow and/or DRB.

The exemplary embodiments relate to enhancements for extended Reality (XR) or industrial Internet of Things (IIoT) applications. Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). However, any reference to XR being specific to a particular use case or type of traffic is merely provided for illustrative purposes. Those skilled in the art will understand that IIoT relates to industrial applications including, for example, production, robotics, and/or medical, that can be implemented in time sensitive networks (TSN) with low latency requirements. Although some of the exemplary embodiments are described with regard to enhancements for XR and/or IIoT services, the exemplary embodiments are not limited to XR or IIoT services and may apply to any type of NR traffic that may be subject to processing requirements imposed by an external application.

During operation, some services may utilize multiple data flows in the uplink (UL) and/or downlink (DL). From a physical channel perspective, there may be different control channels and shared channels for each stream or multiple streams may share a control channel and/or shared channel. In some configurations, each stream may have different quality of service (QoS) requirements (e.g., block error rate (BLER), latency requirements, etc. ). Additionally, a UE may transmit data on the UL that is forwarded to another UE on the DL or transmit data directly to another UE via, e.g., a sidelink (SL) or WiFi.

In addition, the exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. With regard to XR, in some configurations, the UE may be paired with a wearable device (e.g., a head mounted display (HMD), AR glasses, etc. ). In this type of configuration, the UE may communicate directly with the network and then relay data to the wearable device which presents the XR content to the user (e.g., AR, VR, MR, etc.). In other configurations, the UE may be a wearable device that communicates directly with the network and presents the XR content to the user. Therefore, the UE as described herein is used to represent any electronic component that directly communicates with the network.

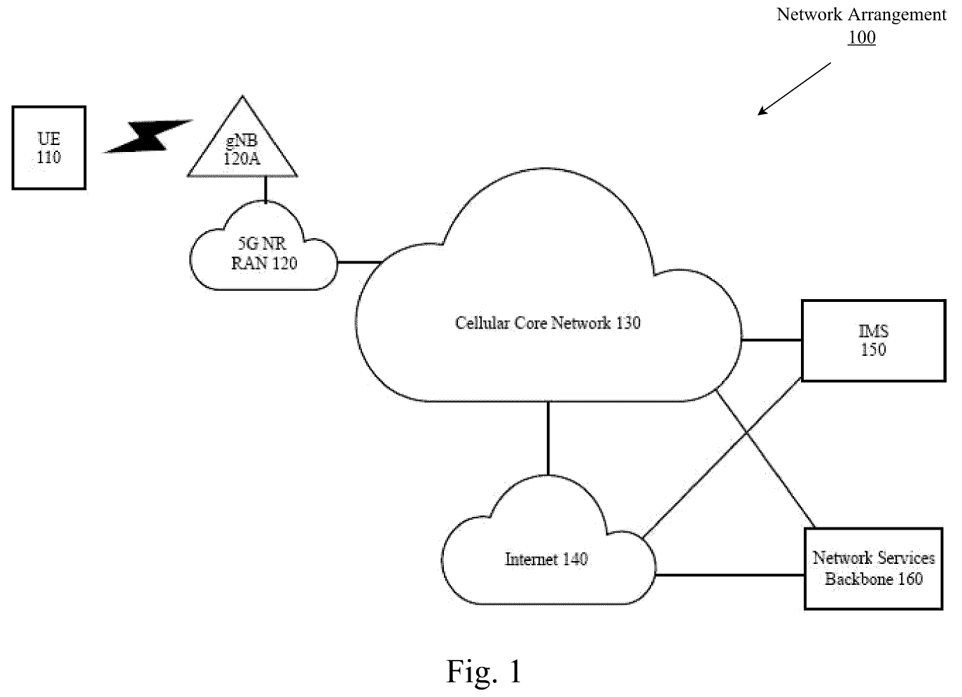

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, industrial IoT (IIoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

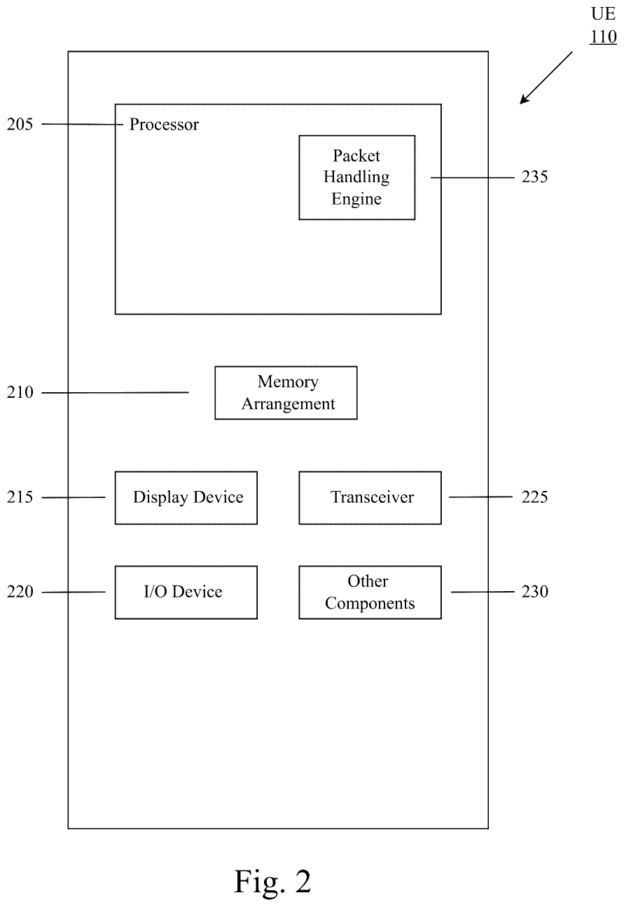

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a packet handling engine 235 for performing various operations related to receiving or determining information related to a current or anticipated upcoming data usage for one or more applications, to be described in detail below. The packet handling engine 235 may also perform operations related to initiating a QoS flow to DRB remapping or packet shifting and providing assistance information to the network with respect to current or anticipated upcoming data usage, to be described in detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

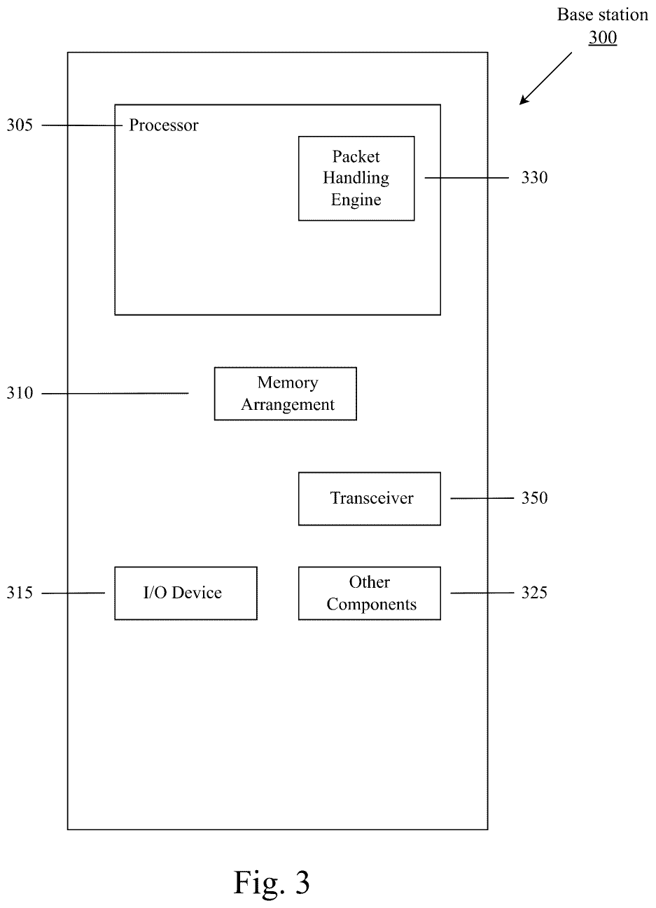

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include packet handling engine 330 for performing operations related to configuring a UE to perform various UE-initiated operations with respect to QoS flow to DRB remapping or packet shifting, to be described in detail below. The packet handling engine 330 may also perform operations related to receiving UE-initiated remapping requests and/or assistance information, admitting packets that have been remapped to a different DRB, and performing actions in dependence thereon, to be described in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In XR (and/or cloud gaming), application traffic on the downlink (DL) may comprise encoded video or scene information. Some XR applications may require a minimum granularity of application data to be available on the client side prior to performing the next level of processing. For example, in some configurations, client processing of application data may begin only once all bits of a video frame, or a certain percentage of those bits, are available to the client device. This application data may be, for example, a video frame that may be packetized into multiple IP payloads.

This minimum granularity of information required by a given application may be referred to as an “Application Data Unit” (ADU) or PDU set. XR (and/or cloud gaming) traffic comprises bursts of traffic that can carry one or more ADUs or PDU set. Each ADU or PDU set can comprise a number of PDUs or packets, e.g., 3 or 4 IP packets. The number of packets included in an ADU or PDU set may vary within a given application and across different applications depending on the data included therein. Thus, depending on the XR application, the size of the ADUs or PDU sets may be different. It should be understood that three or four IP packets is an example and the ADU or PDU set may include any number of IP packets, ethernet packets, or other kind of packet. The packets belonging to a particular ADU or PDU set may be transmitted across multiple data streams or in the same data stream. The exemplary embodiments are not limited to XR or IIoT services and provide enhancements generic to the 5G user plane that can be applied to any type of service. In addition, the exemplary embodiments are not limited to IP traffic and may be applied for any type of packet including at least Ethernet packets, see TS 23.501, clause 5.7.6.

The 5G-RAN and 5GC ensure quality of service (QoS) by mapping packets to appropriate QoS flows and DRBs. The entities involved in packet handling of downlink (DL) data and uplink (UL) data for a UE generally include a user plane function (UPF) of the 5GC (e.g., an instance of the UPF), a base station (gNB) and the UE. Each of these entities identifies certain information about the packet prior to processing the packet. Some access stratum (AS) packet processing functions are performed at the service data adaptation protocol (SDAP) layer of the gNB/UE.

The UPF acts as an external PDU session point of interconnect to a DN and may perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering.

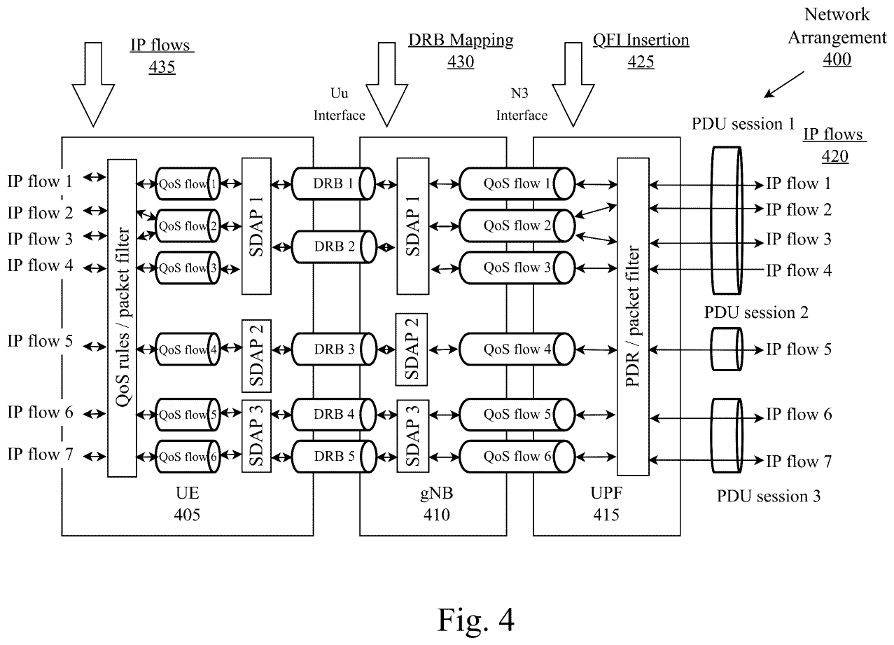

FIG. 4 shows an exemplary network arrangement 400 for QoS flow and DRB mapping according to various exemplary embodiments. The network arrangement 400 includes a UE 405, a gNB 410 and a UPF 415. The QoS flow and DRB mapping is described herein for a downlink traffic flow comprising multiple data streams. However, a person skilled in the art understands that a similar and complementary process may also occur on the uplink.

In a first step for DL packet handling, at the non-access stratum (NAS) level, the UPF 415 receives IP data flows 420 from a data network (DN) via one or more PDU sessions. Each PDU session may correspond to a connection with a different data network (DN) and/or the Internet. In the example of FIG. 4, the UPF 415 receives a first IP flow (IP1), a second IP flow (IP2), a third IP flow (IP3) and a fourth IP flow (IP4) via a first set of PDU sessions (PDU 1). The first set of PDU sessions may comprise, for example, Internet PDU sessions, and the IP flows 1-4 may correspond to video streams, e.g., YouTube or Skype video streams. The UPF 415 receives a fifth IP flow (IP5) via a second set of PDU sessions (PDU 2), e.g., a streaming service PDU session, and IP5 may correspond to a video stream, e.g., a Netflix stream. The UPF 415 receives a sixth IP flow (IP6) and a seventh IP flow (IP7) via a third set of PDU sessions (PDU 3). The third set of PDU sessions may comprise, for example, IMS PDU sessions, wherein IP6 corresponds to a voice stream and IP7 corresponds to a video stream. It should be understood that each of these streams is only exemplary and the streams are not limited to any specific type of data stream.

The UPF 415 processes the received packets using a Service Data Flow (SDF) traffic filter template, e.g., a packet filter. The UPF 415 maps the IP flows to QoS flows based on packet detection rules (PDR) configured by the 5GC. The UPF 415 associates a QoS flow identifier (QFI) with the IP flows by inserting a QFI into the packets (step 425) and transmitting the packets to the gNB 410 over the N3 interface via e.g., a GTP-U tunnel. In the example of FIG. 4, IP1 maps to a first QoS flow (QFI=1), IP2 and IP3 map to a second QoS flow (QFI=2), IP4 maps to a third QoS flow (QFI=3), IP5 maps to a fourth QoS flow (QFI=4), IP6 maps to a fifth QoS flow (QFI=5), and IP7 maps to a sixth QoS flow (QFI=6).

In a second step, at the AS level, the gNB 410 receives the QoS flows from the UPF 415 via N3 and maps the QoS flows to DRBs via one or more instances of the SDAP layer based on QoS profiles/mapping configured by the network. The DRB defines the packet treatment on the radio interface (Uu) and serves packets with the same packet forwarding treatment. The QoS flow to DRB mapping by the gNB 410 is based on QFI and the associated QoS profiles (i.e., QoS parameters and QoS characteristics) configured by the 5GC. The QoS profiles for the respective QFIs are provided by the AMF to the 5G-RAN (gNB 410).

Separate DRBs may be established for QoS flows requiring different packet forwarding treatment, or several QoS flows belonging to the same PDU session can be multiplexed in the same DRB. The gNB 410 associates a DRB ID with the QoS flows and transmits the packets to the UE 405 over the air interface (Uu). In the example of FIG. 4, the first QoS flow maps to a first DRB (DRB=1), the second and third QoS flows map to a second DRB (DRB=2), the fourth QoS flow maps to a third DRB (DRB=3), the fifth QoS flow maps to a fourth DRB (DRB-4), and the sixth QoS flow maps to a fifth DRB (DRB=5). Several QoS flows belonging to the same PDU session can be mapped to the same DRB, while QoS flows belonging to different PDU sessions cannot be mapped to the same DRB.

In a third step, at the UE level, the UE 405 receives the data in the DRBs over the air interface via one or more instances of the SDAP layer. The QoS flows are mapped by the 5GSM layer to IP flows according to packet filters contained in QoS rules configured by the 5GC. The PDRs at the UPF 415 and the QoS rules at the UE 405 may include similar and complementary packet filters. Thus, the original IP packets are extracted and delivered to the higher layers. It should be understood that when IP flows are generated by the UE 405 for UL transmission, the 5GSM layer similarly maps IP flows to QoS flows according to the packet filters contained in the QoS rules.

As described above, QoS flow to DRB mapping is performed at the RAN/gNB (access stratum (AS)) at the SDAP layer. Several QoS flows belonging to the same PDU session can be mapped to the same DRB, while QoS flows belonging to different PDU sessions cannot be mapped to the same DRB. The RAN can add new DRBs with corresponding QFI mappings to fulfill the QoS characteristics of a QoS Flow. The UE determines the UL data QoS binding either via explicit RRC signaling or via reflective QoS (RQoS) based on a DL data QoS marking, to be described in greater detail below.

The exemplary embodiments relate to extensions of the QoS flow to DRB mapping step described above. The exemplary techniques may enable more dynamic QoS adaptation and related user plane enhancements. Some techniques may also facilitate better treatment of groups of packets characterized by a PDU set or in ADU-based QoS.

A mapping between a QoS flow and a DRB may be decided by the gNB and can comprise explicit signaling or reflective QoS (RQoS). In an explicit mapping technique, the gNB uses RRC signaling, e.g., explicit QoS signaling, to indicate, for the UL traffic of the UE, which QoS flow is sent over which DRB. In a reflective QoS technique, the gNB includes an indication, e.g., RDI bit, in a DL packet that triggers the UE to update its UL mapping table based on the QFI and DRB for the DL packet. The UE monitors DL traffic to determine on which DRB a QoS flow was received and, after the RDI bit and the QFI/PQFI is received and the UE updates its mapping table, the UE sends UL traffic over the same DRB and with the same QoS flow. These techniques make it possible for the network to send DL data for a single QoS flow in different DRBs. This provides a useful tool for the gNB to provide different packet forwarding or priority treatment for some packets with a single QoS flow.

One SDAP entity is established at the UE and the gNB for each individual PDU session, as described above. The SDAP layer performs the mapping between a QoS flow and a DRB. When explicit RRC signaling is used, the UE SDAP is configured with QFI-to-DRB mapping rules to indicate which QoS flow is sent over which DRB, including DL and UL mapping rules. When reflective UL mapping is used, the UE SDAP updates its UL mapping tables based on the QFI of received DL packets, to be described below. If no mapping rule is defined, the UE uses a default DRB for a QoS flow. The SDAP of the transmitting entity (UE or gNB) can add an SDAP header to mark QFI in UL or DL data packets, for various reasons to be explained below.

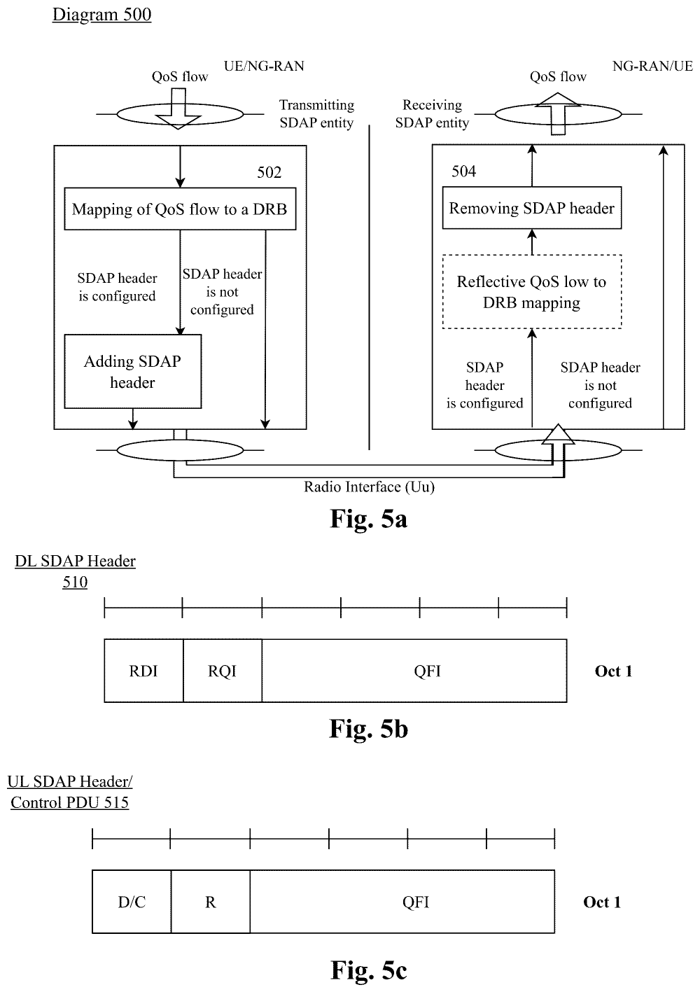

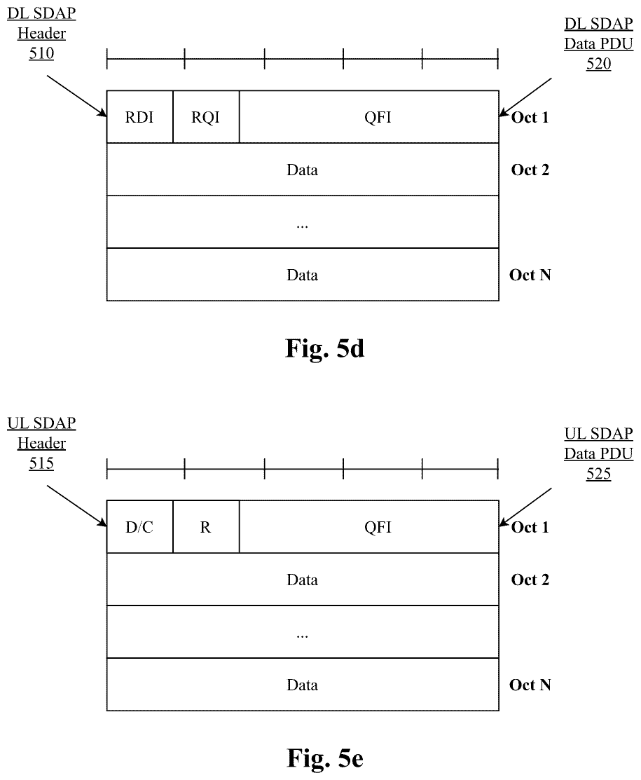

FIG. 5a shows a diagram 500 for QoS flow mapping at the SDAP layer according to various exemplary embodiments. The diagram 500 includes a transmitting SDAP entity 502 (e.g., UE or gNB) receiving a QoS flow from higher layers, e.g., an application layer (for UL traffic at the UE) or the UPF (for DL traffic at the gNB), and mapping the QoS flow to a DRB based on the QoS flow mapping configuration. If the SDAP header is configured for the DRB, then the transmitting SDAP entity 502 adds the SDAP header prior to transmission over the Uu interface. The SDAP header is configured on a UL or DL DRB whenever reflective QoS is enabled and on a UL DRB when more than one QoS flow is mapped to the same DRB. A receiving SDAP entity 504 (e.g., UE or gNB) processes the packet and, if the SDAP header is configured, performs reflective QoS flow to DRB mapping, removes the SDAP header, and transmits the QoS flow to the UPF (for UL traffic at the gNB) or the 5GSM (for DL traffic at the UE).

On the DL, the gNB can add QFI (QoS Flow Indication) and ROI (Reflective QoS Indication) and/or RDI (Reflective QoS flow to DRB mapping Indication) in the DL SDAP header. The DL header is needed only if reflective mapping is used, which is optional for the gNB.

FIG. 5b shows a DL SDAP header 510 according to various exemplary embodiments. The DL SDAP header 510 comprises an octet (one byte) with a QFI field (6 bits), an RQI bit and an RDI bit. The RQI bit can indicate the UE NAS to update its reflective mapping tables for service data flows (SDF) to QoS flow and the RDI bit indicates the UE AS to update its reflective mapping tables for QoS flows to DRBs.

On the UL, the UE can add QFI and D/C (data/control) in the UL SDAP header. The UL header is required when more than one QoS flow is mapped to a DRB (to indicate which QoS flow the DRB is carrying).

FIG. 5c shows a UL SDAP header 515 according to various exemplary embodiments. The UL SDAP header 530 comprises an octet (one byte) with a QFI field (6 bits), a D/C bit and a reserved (R) bit. The D/C bit can indicate if the SDAP header carries an UL SDAP control PDU or UL SDAP data PDU. One bit of the UL SDAP header is not currently allocated for a parameter (a reserve (R) bit).

The UL SDAP data PDU can carry traffic with QFI marked to distinguish between multiple QoS flows mapped to a single DRB. The UL SDAP control PDU (e.g., SDAP header with no data) is used as a UL end-marker for a data flow (DRB) after the gNB has remapped a QoS flow to a different DRB and indicated/configured the new mapping rule.

TS 37.324 defines a UL SDAP end-marker control PDU. The SDAP end-marker control PDU is specific to SDAP and applies to QoS at the access stratum (AS) level only. There is no associated timer. An end-marker may be used when the QoS flow to DRB mapping changes and is applicable to both reflective and RRC configured QoS mapping (see TS 38.300, TS 37.324, TS 38.331).

Reflective QoS (RQoS) at the AS level allows the network to use the RDI field to steer specific QoS flows from one DRB to another, e.g., to enhance the QoS handling in a window of time.

FIG. 5d shows a DL SDAP data PDU format 520 with a DL SDAP header 510 according to various exemplary embodiments. When the RDI bit is set in the DL SDAP header 510, the UE receiving the PDU 520 can update its mapping tables for UL transmissions for the same QFI.

The UL packets belonging to the same QFI are steered by the UE to the same DRB on which the DL packet 520 is received. To complete the remapping, the UE also sends an SDAP end marker control PDU 515 as a last packet on the old DRB that was associated with the QFI. The UL control PDU 515 indicates to the network that no more packets belonging to the (remapped) QFI will be sent over the old DRB from that point onward.

FIG. 5e shows a UL SDAP data PDU format 525 with a UL SDAP header 515 according to various exemplary embodiments. When the QFI is set in the UL SDAP header 515, the gNB can distinguish between multiple QoS flows mapped to a single DRB.

As described above, traffic that consists of multiple modalities (e.g., video, data, control, audio, etc.) often requires data transmission in multiple parallel QoS flows. Some of the traffic flows may possess high throughput and low latency requirements, while other traffic flows may have more relaxed requirements. Examples include XR or IIoT related use-cases. Depending on the mapping of QoS flows to logical channels, the queues (buffer) at the UE side can then fill up very quickly. In addition, delays on one DRB can lead to a degradation of user experience due to packets being processed outside of acceptable latency bounds.

For these reasons, it can be beneficial for the UE to influence the selection of DRB resources. As described above, according to current specification, only the gNB/network side can trigger an update of the QoS flow to DRB mapping by using explicit signaling or reflective QoS as described above.

It will be understood by those skilled in the art that the mapping of QoS flows may become more flexible in the future. For example, the UE may be able to request or initiate a remapping of QoS flows to DRBs, e.g., according to techniques outside the scope of the present disclosure and discussed in brief herein. In another example, one QoS flow may be mapped to multiple DRBs (the restriction that one QoS flow can be mapped to only one DRB can be lifted). The UE will be able to initiate a QoS flow mapping or remapping, for example, to flexibly steer packets from one DRB to another, when necessary. Assuming some future enhancements to the QoS mapping framework, the UE may be able to utilize input from higher layers to trigger a mapping of QoS flows within the network and/or optimize periods with data inactivity to prevent excessive use of system resources.

According to various exemplary embodiments described herein, the UE (e.g., application layer, SDAP, PDCP, RLC, MAC, RRC) can influence the QoS to DRB mapping for a PDU session and trigger/control dynamic QoS adaptations. In some embodiments, the UE (lower layers) receives information/commands from the application layer with respect to a current or anticipated upcoming data usage. In other embodiments, current or anticipated upcoming delays, or the UE not meeting QoS requirements, on one DRB can trigger the UE to remap one or more UL packets for a QoS flow to a DRB different from the DRB mapped for the QoS flow, based on, e.g., LCH buffer status for a DRB. In some embodiments, active queue management (AQM) techniques can be used to, e.g., alert the UE of a high buffer status (or high buffer residency time) for a DRB/LCH. In some embodiments, packets can be shifted to a different DRB without initiating a full remapping of the QoS flow based on, e.g., buffer status, buffer residency time, QoS misfit, or the reception of a time-sensitive (critical) packet. In still other embodiments, an end of traffic indicator and/or data inactivity timer indicator can be used to suggest the network to perform a QoS adaptation.

Compared to the network, the UE has more accurate information about its applications that are currently active as well as typical data traffic activity. Thus, the UE may be in a better position to predict if a particular QFI needs higher or lower QoS (potentially associated with a different DRB) at a given point in time. The UE can further predict for how long a QoS remapping should last (for example, in a temporary short succession of data activity over an otherwise common bearer), whether the traffic pattern is bursty, or one shot activity, etc.

In these embodiments, it is assumed that a UE in the future may be able to influence the mapping of QoS flows to DRBs. The actual methods for the QoS remapping on the access stratum (AS) level are substantially outside the scope of the present disclosure, but it is assumed that such mechanisms are available. In some of the presently described embodiments, certain types of UE-initiated remapping mechanisms are considered. In one example, the UE can initiate UL reflective QoS, where the UE transmits a QoS flow on a DRB different from the currently mapped DRB along with a remapping indication (e.g., a RDI bit). In another example, the UE can temporarily shift packets to another DRB without initiating a full remapping. In another example, the UE can use UL RRC signaling, e.g., a UE assistance information message, to request a remapping.

In addition, the current 5G QoS model does not allow the same QoS flow on multiple DRBs. To make the solutions described herein more efficient, the network restriction that one QoS flow can be mapped to one and only one DRB may be lifted. 5G Advanced may allow for the one to many mapping of QoS flows to DRBs (one QoS flow to be mapped to multiple DRBs).

According to one aspect of these exemplary embodiments, the application layer can provide information, Suggestions or commands to the lower layers (e.g., SDAP, RRC) regarding current or upcoming traffic on particular QoS flows. The information received from the application layer can influence the lower layers with respect to QoS flow remapping decisions.

In some examples, the UE may have application information related to real time video applications, where videos are created in real-time, video game live streaming applications, or real-time broadcast player gaming applications. In another example, live stream applications Twitch and MOB (multi-player mobile on-line battle game) are two applications with traffic patterns without QoS (e.g., over a common bearer/QFI/QCI) that are characterized by large packet sizes and a certain UL/DL packet interval distribution. MOB in particular is sensitive to delay and jitter.

In some embodiments, applications may indicate, to the lower layers of the UE (e.g., SDAP, RRC), current or upcoming changes to QoS requirements for different traffic flows by directly providing metrics and/or related meta-data to the modem. In other embodiments, an AT (e.g., “attention”) command, specified in TS 27.007, can be used to direct the modem to take some action. Specific application programing interfaces (APIs) could be provided to an application developer to take advantage of the UE capability to initiate dynamic remapping of QoS flows to DRBs.

Along with the enhanced QoS flow to DRB mapping approaches discussed above (e.g., UE-initiated remapping and/or the allowance of one-to-multiple QoS flow to DRB mapping), and in view of information/commands received from the application layer, the UE can utilize foreground and background traffic and put some background traffic on a best effort bearer (or another bearer with lower QoS) much more dynamically. These embodiments allow for the fast remapping (distribution) of QoS flows to DRBs according to application layer influence and/or changing application demands.

In another aspect of these exemplary embodiments, the UE lower layers (e.g., SDAP, PDCP, RLC or MAC) can detect events that can trigger a QoS flow to DRB remapping and/or a shift of packets from one DRB to another DRB. In some embodiments, an event such as a high buffer status or high buffer residency time can be detected on a DRB/LCH that triggers a remapping of a QoS flow to a different DRB/LCH. In other embodiments, certain packets can be shifted in a temporary or one-shot manner. These embodiments may relate to active queue management (AQM) techniques implemented at the SDAP, PDCP, RLC, or MAC layer. The SDAP maps QoS flows to DRBs, as described above. The RLC maps DRBs received from SDAP/PDCP to logical channels (LCH) for transmission to the medium access control (MAC) layer. When packets are received at these entities (or generated by the entities) of the UE on the UL for transmission to lower layers and/or the network, the packets enter one or more transmission queues or buffers. From the queue/buffer, the packets can be sequentially/progressively submitted to lower layers for further processing and transmission to the network.

In some embodiments, the UE (e.g., at an L2 layer) can detect events including, e.g., a high buffer status, a high buffer residency time, a high retransmission rate, a high round trip time (RTT), the UE nearing the packet delay budget (PDB) for a given flow (e.g., based on the PDCP discard timer or according to a new parameter configured by the network, or based on an estimation internal to the UE and relating to the PDB for the 5QI/QFI), a PDU Set delay threshold, a packet error rate, a PDU Set error rate, or the UE has entered survival time state, for packets on a particular logical channel (LCH) (for a DRB). The UE can receive packets from the higher layers that enter a LCH/DRB queue or lower layer queue per DRB. If the UE detects a particular event with respect to the received packets, e.g., a high buffer status for a given LCH, the UE can provide feedback to the higher layers (e.g., SDAP, RRC) that triggers a remapping of the QoS flow to a different DRB and/or a shifting of packets/PDUs to the different DRB/LCH without a full remapping for the QoS flow. The LCH to which the packets are shifted may be associated with a lower buffer status or delay.

The various thresholds that may trigger feedback to the SDAP or RRC, e.g., buffer, residency time, retransmission and/or RTT thresholds, can be configured by the network. The network can further configure packet shifting and/or QoS flow remapping parameters for the UE, including, e.g., DRBs eligible for packet shifting, specific DRBs to which packets should be shifted, etc.

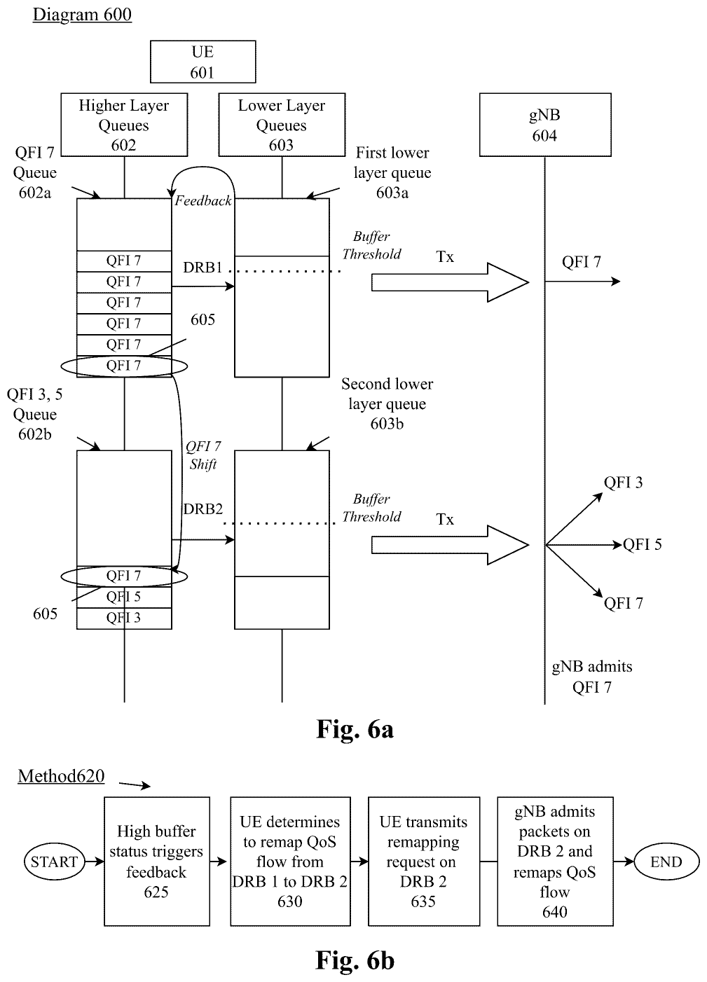

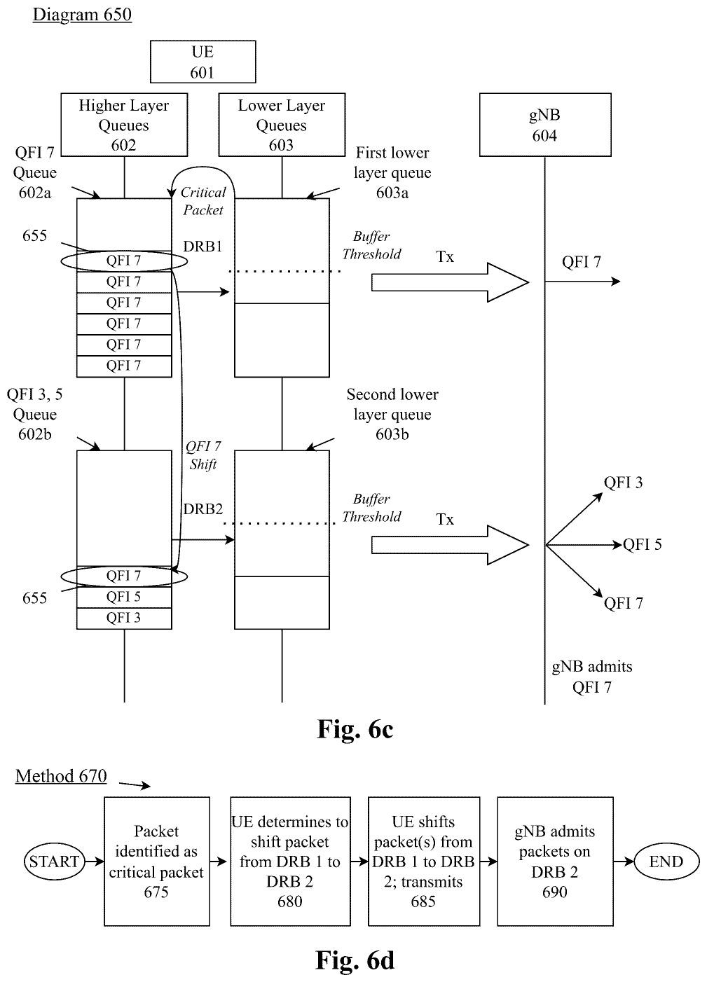

FIG. 6a shows an exemplary diagram 600 for a UE 601 remapping one or more packets from a first DRB to a second DRB based on buffer status according to various exemplary embodiments. The diagram 600 shows higher layer queue(s) 602 and lower layer queue(s) 603 for the UE 601. It is noted that, based on UE or gNB implementation, a queue may be associated with one or multiple different layers depending on how the memory is organized. In some embodiments, the lower layer queue(s) 603 can be, e.g., associated with the PDCP layer, a logical channel (LCH) or DRB queue associated with the RLC layer, or associated with the MAC layer. In some embodiments, the higher layer queue(s) 602 can be, e.g., associated with the application layer or the SDAP layer. Those skilled in the art will ascertain that the higher layer queues 602 and the lower layer queues 603 may be linked to different actual layers (or multiple layers) in different implementations. In some cases, the higher layer queue can be in PDCP, which performs ciphering, and the lower layer queue can be RLC or MAC, where the packets are remapped. In such a case, the receiver would use a COUNT value from a PDCP of another DRB to decipher the packets, that is, unless the packet shifting happens before enciphering. In yet another case, an implementation may use a common queue for both higher and lower layers.

A first higher layer queue 602a corresponds to the first DRB (DRB1) and a second higher layer queue 602b corresponds to a second DRB (DRB2). Packets/PDUs on DRB1 include QoS flow 7 (QFI 7) and packets/PDUs on DRB2 include QoS flows 3 and 5 (QFI 3,5) according to the currently configured QoS flow to DRB mapping table. Packets for QFI 7 in the first higher layer queue 602a map to DRB1 and are submitted to the lower layers (e.g., PDCP or lower) to a first lower layer queue 603a and packets for QFI 3,5 in the second higher layer queue 602b map to DRB2 and are submitted to the lower layers to a second lower layer queue 603b. From the lower layer queues 603, the packets are transmitted to the gNB 604 where the QoS flows are identified and transmitted to the UPF.

The lower layer queues 603 are configured with respective buffer thresholds or thresholds representing a buffer residency time. If the buffer size for the queue 603 exceeds the threshold a high buffer status can be detected at the UE 601. In the present example, the first lower layer queue 603a has a high buffer status that triggers an alarm or feedback message from the lower to the higher layers. In response, the higher layers (e.g., SDAP or higher) determine to shift one or multiple packets for QFI 7 from the first higher layer queue 602a (DRB1) to the second higher layer queue 602b (DRB2), e.g., to fulfill the packet delay budget or mitigate packet starvation. The second higher layer queue 602b can have a low buffer status within its respective threshold. The buffer status for the second queue 602b may be checked prior to selecting the DRB2 as the destination for the one or multiple packets of QFI 7.

In the present example, the UE 601 determines that the QoS flow of QFI 7 should be remapped from DRB1 to DRB2. In other embodiments, the UE may shift one or multiple packets to DRB2 without requesting a remapping. The UE 601 transmits the packets according to UE-initiated remapping techniques, to be described in greater detail below. The gNB 602 admits the QFI 7 packets on DRB2 and remaps the QoS flow from DRB1 to DRB2.

To request the remapping, the UE can include a bit in the UL SDAP header (e.g., an RDI bit) indicating the UE-initiated remapping request and transmit the packets over a different DRB. Alternatively, the UE can simply update the QFI in the current queue and transmit the packets over a different DRB. The “incorrect” QFI acts as a trigger to remap the QFI to the DRB on which the packets are sent. Prior to transmitting actual packets, the UE can transmit a PDU containing dummy data (e.g., if the network is set up to discard PDUs with unexpected QFIs) or can transmit an SDAP Control PDU. A dummy packet refers to a transmission where the SDAP header is correct and valid but the payload indicates only dummy data (such as padding).

These embodiments assume the gNB accepts all QFIs (or a configured set of DRBs, or a certain range or subset of QFIs). A gNB supporting this feature should not discard the received PDU (due to unexpected DRB-to-QoS flow mapping, in case there is such a check). Local breakout refers to a case where a gNB has a local connection to a nearby gateway to the internet, such as some of the cases explained in TS 23.501. Local UPF refers to edge computing (where, in some configurations, a gNB and a UPF maybe collocated). The gNB may employ a validity check on received packets. If the QFI does not match the QoS-flow-to-DRB mapping configured for the DRB then some gNBs may discard the packet. However, this depends on gNB implementation. In other cases, the gNB may simply route packets to an outgoing link based on the received QFI and not check the QoS-flow-to-DRB mapping. Moreover, such a check is typically associated with the gNB-CU (where PDCP and SDAP are located). A gNB-DU may have similar checks as well, but it is less likely or not necessarily the case because it is not supposed to check the SDAP header. Assuming a gNB-CU would not run such a check when, e.g., the UPF is located a large distance away and there is one (or few) outgoing link(s) to the N3 interface, if the gNB is combined with a local UPF or a local breakout then such a check needs to be there at some place. The levels (where to perform which part of the check) are part of gNB/UPF implementation.

FIG. 6b shows a method 620 for a UE 601 remapping packets from a first DRB to a second DRB based on buffer status according to various exemplary embodiments. The method 620 of FIG. 6b is described with respect to the diagram 600 of FIG. 6a.

In 625, a high buffer status is detected in a first lower layer queue for a first DRB carrying a first QoS flow (QFI 1) and the higher layers are notified, e.g., via an alarm or feedback message. In other embodiments, the feedback message may relate to a different type of event detection, e.g., a high delay (round trip time), buffer residency time or retransmission rate for packets in the first lower layer queue. These events detection thresholds can be configured by the network for particular DRBs/LCHs or all DRBs/LCHs.

In 630, the UE 601 (e.g., SDAP) determines to remap the first QoS flow (QFI 1) from DRB1 to DRB2. Before selecting the DRB2, the UE 601 can first determine that the buffer size for the second lower layer queue of DRB2 is within a predetermined threshold, or the UE 601 can assume this, e.g., because no alert has been received regarding the second lower layer queue. Alternatively, the remapping to DRB2 may be configured by the network.

In 635, the UE 601 (e.g., SDAP) initiates a remapping of QFI 1 from DRB1 to DRB2. In some embodiments, in the SDAP header for at least one of the packets, the UE 601 includes the RDI bit indicating the UE request to remap QFI 1 from DRB1 to DRB2. In other embodiments, the RDI bit is not used. The UL SDAP data PDU (with data or with dummy data) or control PDU can be used. The request is transmitted on DRB2.

In 640, the gNB 602 receives the packets (e.g., with the RDI bit), admits the packets based on gNB implementation and remaps the QFI 1 to DRB 2.

In other exemplary embodiments, the UE can shift one or multiple packets to a different DRB without requesting or initiating a remapping. For example, some packets (e.g., control data) may be eligible to be remapped to a different DRB under certain circumstances. In these embodiments, the RDI bit can indicate the presence of an unmatched QFI in a one-time manner, where the rerouting of the packet is considered an exception or a special case.

In some embodiments, certain packets may be identified as critical packets within a QoS flow itself (e.g., at the SDAP layer) and shifted to a different DRB, e.g., carrying traffic with different QoS requirements. In some examples, multiple QoS flows with different QoS requirements may be mapped to the same DRB, where some packets may be temporarily shifted to a different DRB under some circumstances.

The identification of the critical packets can be configured by the network or defined in specification. The network can further configure packet shifting and/or QoS flow remapping parameters for the UE, including, e.g., DRBs eligible for packet shifting, specific DRBs to which packets should be shifted, etc.

FIG. 6c shows an exemplary diagram 650 for a UE 601 shifting one or more packets from a first DRB to a second DRB based on a critical status of the packets according to various exemplary embodiments. The diagram 650 is arranged similarly to the diagram 600 of FIG. 6a.

In this example, no feedback is received from the RLC/MAC regarding the lower layer queues 603 regarding buffer size or any other parameter (although this method can be combined with feedback, where a critical packet is eligible for remapping only after feedback is received as a trigger). Rather, in this example, a specific packet 655 for QFI 7 in the first higher layer queue 602a (DRB1) is identified as a critical packet. The critical packet can have time-sensitive requirements and/or a priority associated therewith, relative to other packets with QFI 7. For example, QFI 7 can carry both Real-time Transport Protocol (RTP) and RTP Control Protocol (RTCP) packets. Some packets, e.g., control data, may be eligible to be remapped to a different DRB when certain conditions are met based on network configuration.

When the critical packet is detected in the first queue 602a, the higher layers determine to shift the packet for QFI 7 from the first higher layer queue 602a (DRB1) to the second higher layer queue 602b (DRB2). The second higher layer queue 602b (DRB2) can be, e.g., a default destination for certain types of packets.

In another option, the UE 601 can shift the critical packet to a lower position in the first buffer 602a so that the critical packet can be transmitted more quickly on the mapped DRB 1.

In the present example, the UE 601 does not remap the QoS flow of QFI 7 to DRB 2, e.g., does not include the RDI bit. The gNB admits the time-critical QFI 7 packets on DRB2.

FIG. 6d shows a method 670 for a UE 601 shifting one or more packets from a first DRB to a second DRB based on a critical status of the packets according to various exemplary embodiments. The method 670 of FIG. 6d is described with respect to the diagram 650 of FIG. 6c.

In 675, a packet (QoS flow), e.g., with QFI 1, is received in a first higher layer queue for a first (mapped) DRB and the packet is identified as a critical packet. Different types of critical packets can be identified, e.g., time-sensitive and/or priority packets.

In 680, the UE 601 (e.g., SDAP) determines to shift the critical packets for the first QoS flow (QFI 1) from DRB1 to DRB2. The UE 601 can determine the packet shifting based on the type of critical packet, configuration from the network, predefined rules, buffer status, etc. In other embodiments, the UE can shift the critical packet lower in the current queue (DRB1) instead of to DRB2.

In 685, the UE 601 (e.g., SDAP) shifts the critical packet for QFI 1 from DRB1 to DRB2. In this example, the UE 601 does not include the RDI bit indicating the UE request to remap QFI 1 from DRB1 to DRB2. In another option, the R bit is indicated to identify the presence of an unmatched QFI in a one-time manner. In other words, the rerouting of QFI 1 over DRB2 is considered an exception or special case.

In 690, the UE 601 transmits the packets for QFI 1 on DRB2. The gNB 602 receives the packet and admits the packet based on gNB policy rules. No remapping of QFI 1 is performed.

In still another aspect of these exemplary embodiments, the UE can indicate an end of traffic indicator to the network. The end of traffic indicator can comprise a UL SDAP header with a value of, e.g., QFI=0 or QFI=0x3F (63). The end of traffic indicator can be included in a UL SDAP Data PDU or an UL SDAP Control PDU, as shown in FIGS. 5e and 5c.

According to NAS spec TS 24.501, the network shall not set QFI 0—so QFI=0 is not allocated to the UE. In 5G NAS, QFI 0 is currently considered a “syntactical error”, except for the UE-requested PDU session modification procedure where the UE shall set the QFI values to “no QoS flow identifier assigned” in the Requested QoS flow descriptions IE, if the QoS flow descriptions are newly created. per RAN3 and SA2 specifications, any QFI value between 0 and 63 is considered a valid QFI. It is noted that SDAP carries user plane data (DRB) and NAS carries control plane traffic (SRB) which configures, e.g., QoS rules for a PDU session related with a DRB.

According to another aspect of the exemplary embodiments, specific QFI values can be declared as “special values” that can be used as an end of traffic indicator for one or multiple QFIs (after the QFI was allocated). In a first option, the UE sets the QFI to all 0 (or all 1), and the reserved bit is set to 1 in the UL SDAP header (for a data PDU or control PDU). The reserved bit is used as an (optional) additional identifier to denote the presence of a special QFI value or the presence of an end-of-traffic indication. This indicates that the UE has no more new UL data in the foreseeable future and network may use this to release the connection immediately. In present operations, the network would typically wait for some duration of inactivity, e.g., ˜10 seconds.

In this option, no new header fields are introduced and only the QFI field is modified so that one or more QFI values are specified as “special” values that indicate the end of traffic. That is, detection of an end-of-traffic indication is solely based on the QFI value alone. The reserved bit “R” in the SDAP header is kept unchanged (0).

The UE may use application or higher layer influence to determine or declare the end of traffic. For example, the UE may use this option right after TCP FIN is received from the application layer or after the socket (connection) closes. Whether to release the connection is a network decision, but here the UE can provide a suggestion to the network.

The UL SDAP header can be used to indicate the end of traffic for one or more DRBs. In a first option, the UE indicates end of traffic (QFI=0 or 0x3F) in any SDAP uplink packet, which is then valid for all DRBs. In a second option, the indication is defined on a per DRB basis. Certain DRBs can be configured to use QFI 0 or QFI=0x3F as an end of traffic indicator, which applies to the DRB on which the feature is configured. In a third option, the R-bit can be used, e.g., in combination with the special QFI value or alone.

Some thresholds can be configured at the UE side regarding how frequently the end of traffic indicator can be sent, so as to avoid fluctuating between sending end of traffic indicators and scheduling requests (SR) in short succession. In another option, UE assistance information can be transmitted via UL RRC to indicate to the network the intention to release the connection.

In other embodiments, the assistance information can relate to the network-implemented dataInactivityTimer. This timer can be used by the network to trigger the release of a connection (and subsequent remapping of QoS flows/DRBs used for the connection). The UE can share assistance information to the network to set the dataInactivityTimer correctly based on UE knowledge of data traffic characteristics. For example, in use cases such as periodic streaming, some content is typically fetched periodically (e.g., every ‘x’ seconds). The dataInactivityTimer timer can be set differently for different DRBS.

Based on the assistance information provided by the UE, the network can determine to shorten or lengthen the dataInactivityTimer to avoid releasing a connection with e.g., infrequent periodic traffic. The network could further determine to shorten the timer for power saving, optimize effective system capacity in the cell, or to set the timer to the best suitable value from the UE perspective.

In these exemplary embodiments, the UE could indicate in RRC UE assistance information a suggested value or any updates to the dataInactivityTimer used by the gNB based on the UE knowledge of traffic characteristics.

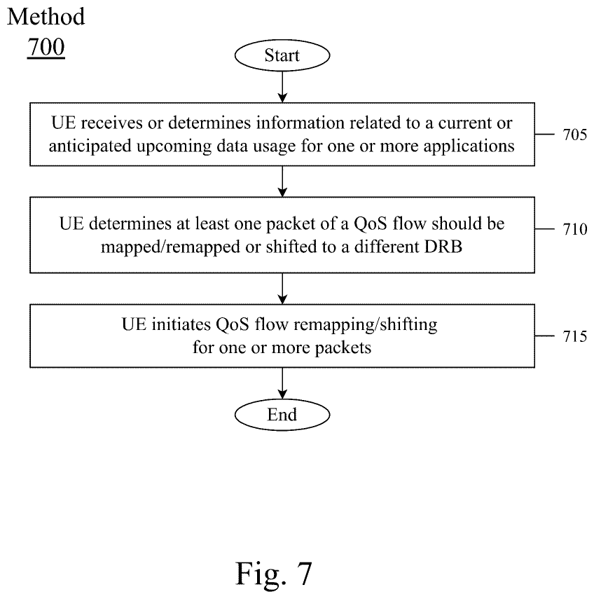

FIG. 7 shows a method 700 for UE-initiated operations for QoS flow to DRB remapping or packet shifting according to various exemplary embodiments.

In 705, the UE receives or determines information related to a current or anticipated upcoming data usage for one or more applications. As described above, in some embodiments, the UE modem can receive information (e.g., metrics, meta-data) or commands (e.g., AT command) from the application layer regarding current or upcoming changes to QoS requirements for different traffic flows. In other embodiments, the UE/DAP/PDCP/RLC/MAC layers) can detect an event, e.g., a high buffer status or the arrival of a critical packet.

In 710, the UE determines, based on the received/determined information, that at least one packet of a QoS flow should be mapped/remapped or shifted to a new DRB. This could be in response to information from the application layer (e.g., application metrics, meta-data, AT command, etc.); packet detections at the application/SDAP layer (e.g., a critical packet); indications from the RLC layer (e.g., a higher buffer, high residency time, etc. for a LCH); and/or buffer status, as described above. The UE actions are based on the type of information/event. For example, based on information from the application layer (e.g., a high anticipated upcoming data usage on a first DRB), the SDAP may determine to remap a QoS flow from the first DRB to a second DRB. In another example, if a high buffer status is triggered at the lower layer queue for a first DRB, the SDAP may determine to remap a QoS flow from the first DRB to a second DRB. In still another example, if a critical packet is received at the SDAP, the SDAP may shift the critical packet from a first DRB to a second DRB without remapping the QoS flow of the critical packet.

In 715, the UE transmits a request or otherwise initiates a QoS flow remapping/shifting for one or more packets in a QoS flow and/or for the entire QoS flow. The UE can initiate a remapping request by transmitting a QFI on a DRB different from a currently mapping DRB for the QFI. In some embodiments, the request can indicate an RDI bit in the UL SDAP header (e.g., a reserved bit). The request can comprise a UL SDAP data PDU (with UL data), a UL SDAP data PDU with dummy data, a UL SDAP control PDU, an UL RRC message, etc. In other embodiments, the UE can indicate a QoS flow remapping for particular packets in a one-shot manner (without requesting a full remapping).

The gNB can admit the transmission based on gNB implementation. The gNB can configure the UE for certain UE-initiated QoS flow/mapping/shifting operations based on UE capability and implement gNB admission rules in accordance therewith. The gNB can reconfigure the UE with a new QoS to DRB mapping table, or simply update its own (shadow) mapping table. In some embodiments, the gNB can admit the packet on a different DRB in a one-shot manner and not remap the QoS flow for the packet.

In some embodiments, together with the QoS remapping described above or independently thereof, the UE can share assistance information with the network regarding current or upcoming traffic. For example, the UE can determine to send an end of traffic indicator to the network. The end of traffic indicator can be associated with all the currently configured DRBs or with a subset of these DRBs. The end of traffic indicator could comprise, e.g., an UL transmission with the QFI set to a special value (e.g., QFI=0 or QFI=0x3F (63). The reserved bit in the UL SDAP header (e.g., RDI bit) can also be used to indicate the end of traffic (potentially in combination with the “special” QFI value, if the RDI bit is used for different purposes). Some thresholds can be configured at the UE side regarding how frequently the end of traffic indicator can be sent. The end of traffic indicator can also comprise a UE assistance message (e.g., UL RRC).

In other embodiments, the assistance information can relate to the network-implemented dataInactivityTimer. The UE can share assistance information with the network to set the dataInactivityTimer correctly based on UE knowledge of data traffic characteristics. The UE could indicate in UL RRC UE assistance information a suggested value or any updates to the dataInactivityTimer. Based on the assistance information provided by the UE, the network can determine to shorten or lengthen the dataInactivityTimer.

The UE can share this assistance information at any time and does not need to follow a QoS flow remapping/shifting, e.g., of steps 710-715 above.

### EXAMPLES

In a first example, a method performed by a user equipment (UE), comprising establishing a protocol data unit (PDU) session including one or more quality of service (QoS) flows and multiple data radio bearers (DRB) for communications with a network, receiving or determining an initial mapping table for a QoS flow to DRB mapping based on a network configuration of mapping parameters, receiving or determining information regarding current or upcoming traffic on the one or more QoS flows or one or more DRBs and transmitting an indication to the network based on the information regarding current or upcoming traffic on the one or more QoS flows or one or more DRBS.

In a second example, the method of the first example, wherein the information regarding current or upcoming traffic comprises a closing of a connection with an application.

In a third example, the method of the second example, wherein the closing of the connection with the application triggers the UE to transmit an end of traffic indication to the network that, when transmitted, indicates the UE has no new uplink (UL) data or does not expect further DL data, wherein, based on the end of traffic indication, the network can release the connection.

In a fourth example, the method of the third example, wherein the end of traffic indication is provided as a special QoS flow identifier (QFI) value in a UL service data adaptation protocol (SDAP) header transmitted in a UL SDAP data protocol data unit (PDU) or control PDU.

In a fifth example, the method of the fourth example, wherein the special QFI value comprises QFI=0 or QFI=0x3F.

In a sixth example, the method of the fifth example, wherein the end of traffic indication further includes a reserved bit in the SDAP header.

In a seventh example, the method of the fourth example, wherein the end of traffic indication is valid for all DRBS.

In an eighth example, the method of the fourth example, wherein the end of traffic indication is valid only for a DRB on which the end of traffic indication is transmitted.

In a ninth example, the method of the third example, wherein the end of traffic indication is provided as a reserved bit in a UL service data adaptation protocol (SDAP) header transmitted in a UL SDAP data protocol data unit (PDU) or control PDU.

In a tenth example, the method of the third example, further comprising receiving a configuration from the network for an end of traffic indication feature.

In an eleventh example, the method of the tenth example, wherein the configuration further includes a threshold duration regarding the frequency with which the end of traffic indicator can be transmitted.

In a twelfth example, the method of the tenth example, wherein the configuration further indicates a subset of the configured DRBs that are eligible for the end of traffic indication feature.

In a thirteenth example, the method of the third example, wherein the end of traffic indication is provided in UL radio resource control (RRC) UE assistance information.

In a fourteenth example, the method of the first example, wherein the information regarding current or upcoming traffic comprises a traffic pattern for an application or a buffer status for a DRB or traffic associated with a PDU session.

In a fifteenth example, the method of the fourteenth example, wherein the indication transmitted to the network relates to a duration for a data inactivity timer for the network and the UE, wherein, when the data inactivity timer elapses, a release of a data connection is triggered at the network and the UE.

In a sixteenth example, the method of the fifteenth example, wherein the indication comprises a suggested value for the data inactivity timer.

In a seventeenth example, the method of the fifteenth example, wherein the indication is transmitted in UL radio resource control (RRC) UE assistance information.

In an eighteenth example, a processor configured to perform any of the methods of the first through seventeenth examples.

In a nineteenth example, a user equipment (UE) comprising a transceiver configured to communicate with a network and a processor communicatively coupled to the transceiver and configured to perform any of the methods of the first through seventeenth examples.

In a twentieth example, a method performed by a base station, comprising establishing a protocol data unit (PDU) session including one or more quality of service (QoS) flows and multiple data radio bearers (DRB) for communications with a user equipment (UE), indicating mapping parameters for the UE to determine an initial mapping table for a QoS flow to DRB mapping, configuring the UE for transmitting an indication to the base station based on information regarding current or upcoming traffic on the one or more QoS flows or one or more DRBs and receiving the indication from the UE.

In a twenty first example, the method of the twentieth example, wherein the information regarding current or upcoming traffic comprises a closing of a connection with an application, wherein the indication comprises an end of traffic indication that indicates the UE has no new uplink (UL) data or does not expect further DL data.

In a twenty second example, the method of the twentieth example, further comprising based on the end of traffic indication, releasing the connection.

In a twenty third example, the method of the twenty second example, wherein the end of traffic indication is received as a special QoS flow identifier (QFI) value in a UL service data adaptation protocol (SDAP) header transmitted in a UL SDAP data protocol data unit (PDU) or control PDU.

In a twenty fourth example, the method of the twenty third example, wherein the special QFI value comprises QFI=0 or QFI=0x3F.

In a twenty fifth example, the method of the twenty fourth example, wherein the end of traffic indication further includes a reserved bit in the SDAP header.

In a twenty sixth example, the method of the twenty third example, wherein the end of traffic indication is valid for all DRBs.

In a twenty seventh example, the method of the twenty third example, wherein the end of traffic indication is valid only for a DRB on which the end of traffic indication is transmitted.

In a twenty eighth example, the method of the twenty second example, wherein the end of traffic indication is received as a reserved bit in a UL service data adaptation protocol (SDAP) header transmitted in a UL SDAP data protocol data unit (PDU) or control PDU.

In a twenty ninth example, the method of the twenty first example, wherein the configuration further includes a threshold duration regarding the frequency with which the end of traffic indicator can be transmitted.

In a thirtieth example, the method of the twenty first example, wherein the configuration further indicates a subset of the configured DRBs that are eligible for the end of traffic indication feature.

In a thirty first example, the method of the twenty first example, wherein the end of traffic indication is received in UL radio resource control (RRC) UE assistance information.

In a thirty second example, the method of the twentieth example, wherein the information regarding current or upcoming traffic comprises a traffic pattern for an application, wherein the indication relates to a duration for a data inactivity timer for the base station, wherein, when the data inactivity timer elapses, a release of a data connection is triggered.

In a thirty third example, the method of the thirty second example, wherein the indication comprises a suggested value for the data inactivity timer.

In a thirty fourth example, the method of the thirty second example, wherein the indication is transmitted in UL radio resource control (RRC) UE assistance information.

In a thirty fifth example, a processor configured to perform any of the methods of the twentieth through thirty fourth examples.

In a thirty sixth example, a base station comprising a transceiver configured to communicate with a user equipment (UE) and a processor communicatively coupled to the transceiver and configured to perform any of the methods of the twentieth through thirty fourth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, an ARM based platform, an AMD based platform, a Windows OS, a LINUX based OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
establish a protocol data unit (PDU) session including one or more quality of service (QoS) flows and multiple data radio bearers (DRB) for communications with a network;
decode, from signals received from the network, or determine an initial mapping table for a QoS flow to DRB mapping based on a network configuration of mapping parameters;
decode, from signals received from the network, or determine information regarding current or upcoming traffic on the one or more QoS flows or one or more DRBs; and
configure transceiver circuitry to transmit an indication to the network based on the information regarding current or upcoming traffic on the one or more QoS flows or one or more DRBS.

2. The apparatus of claim 1, wherein the information regarding current or upcoming traffic comprises a closing of a connection with an application.

3. The apparatus of claim 2, wherein the closing of the connection with the application triggers the UE to transmit an end of traffic indication to the network that, when transmitted, indicates the UE has no new uplink (UL) data or does not expect further DL data, wherein, based on the end of traffic indication, the network can release the connection.

4. The apparatus of claim 3, wherein the end of traffic indication is provided as a special QoS flow identifier (QFI) value in a UL service data adaptation protocol (SDAP) header transmitted in a UL SDAP data protocol data unit (PDU) or control PDU.

5. The apparatus of claim 4, wherein the special QFI value comprises QFI=0 or QFI=0x3F.

6. The apparatus of claim 5, wherein the end of traffic indication further includes a reserved bit in the SDAP header.

7. The apparatus of claim 4, wherein the end of traffic indication is valid for all DRBs.

8. The apparatus of claim 4, wherein the end of traffic indication is valid only for a DRB on which the end of traffic indication is transmitted.

9. The apparatus of claim 3, wherein the end of traffic indication is provided as a reserved bit in a UL service data adaptation protocol (SDAP) header transmitted in a UL SDAP data protocol data unit (PDU) or control PDU.

10. The apparatus of claim 3, wherein the processing circuitry is further configured to:
decode, from signals received from the network, a configuration for an end of traffic indication feature.

11. The apparatus of claim 10, wherein the configuration further includes a threshold duration regarding the frequency with which the end of traffic indicator can be transmitted.

12. The apparatus of claim 10, wherein the configuration further indicates a subset of the configured DRBs that are eligible for the end of traffic indication feature.

13. The apparatus of claim 3, wherein the end of traffic indication is provided in UL radio resource control (RRC) UE assistance information.

14. The apparatus of claim 1, wherein the information regarding current or upcoming traffic comprises a traffic pattern for an application or a buffer status for a DRB or traffic associated with a PDU session.

15. The apparatus of claim 14, wherein the indication transmitted to the network relates to a duration for a data inactivity timer for the network and the UE, wherein, when the data inactivity timer elapses, a release of a data connection is triggered at the network and the UE.

16. The apparatus of claim 15, wherein the indication comprises a suggested value for the data inactivity timer.

17. The apparatus of claim 15, wherein the indication is transmitted in UL radio resource control (RRC) UE assistance information.

18. An apparatus of a base station, the apparatus comprising processing circuitry configured to:
establish a protocol data unit (PDU) session including one or more quality of service (QoS) flows and multiple data radio bearers (DRB) for communications with a user equipment (UE);
indicate mapping parameters for the UE to determine an initial mapping table for a QoS flow to DRB mapping;
configure the UE for transmitting an indication to the base station based on information regarding current or upcoming traffic on the one or more QoS flows or one or more DRBs; and
decode, from signals received from the UE, the indication.

19. The apparatus of claim 19, wherein the information regarding current or upcoming traffic comprises a closing of a connection with an application, wherein the indication comprises an end of traffic indication that indicates the UE has no new uplink (UL) data or does not expect further DL data.

20. The apparatus of claim 18, wherein the processing circuitry is further configured to:
release the connection based on the end of traffic indication.
